(19) United States
(12) Patent Application Publication
(10) Pub. No.: US 2013/0154438 A1
(43) Pub. Date: Jun. 20, 2013

(54) Power-Scalable Betavoltaic Battery

(71) Applicant: Marvin Tan Xing Haw, London (GB)

(72) Inventor: Marvin Tan Xing Haw, London (GB)

(21) Appl. No.: 13/331,202

(22) Filed: Dec. 20, 2011

(51) Int. Cl. G21H 1/06

(52) U.S. Cl. 310/303

(57) ABSTRACT

A betavoltaic battery having layers of fissile radioisotopes 8, moderating material 7, beta-decaying radioisotopes 6, and semiconductor diode 4 & 5 adjacently stacked one above another, is proposed. Neutrons produced by the chain reaction in the fissile radioisotope 8 are slowed down by the moderating material 7 before penetrating into the layer of beta-decaying radioisotope 6 to cause fission. Beta particles produced from the fission of beta-decaying radioisotopes 6 create electron-hole pairs in the semiconductor diode 4 & 5. Electrons and holes accumulate at the cathode 9 and anode 2 respectively, producing an electromotive force. Because beta particles are produced from neutron-induced fission, instead of from beta decay, this betavoltaic battery is able to generate substantially more power than conventional betavoltaic batteries.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE OF THE MATERIAL ON THE COMPACT DISC

Not Applicable

### BACKGROUND OF THE INVENTION

Conventional betavoltaic batteries generate electricity by using semiconductor diodes to collect beta particles from beta decaying radioisotopes such as Ni-63 and H-3. The rate at which beta particles are emitted from the decaying radioisotopes is very slow. Thus, the power generated by conventional betavoltaic batteries is very low.

### BRIEF SUMMARY OF THE INVENTION

This invention proposes the use of neutron-induced fission of beta-decaying radioisotopes to produce beta particles that can be collected by semiconductor diodes to produce electrical power. The rate of emission of beta particles is greatly increased. This allows the semiconductor diode to convert more beta particles into more electrical energy.

### BRIEF DESCRIPTION OF THE SEVERAL VIEWS OF THE DRAWING

FIG. 1 shows a cross-sectional side view of multiple cells stacked to form a parallel circuit.

FIG. 2 shows a cross-sectional side view of multiple cells stacked to form a series circuit.

FIG. 3 shows a side view of a single cell. FIG. 3 shows the relative vertical positions in which the different layers of material have to be deposited on top of each other.

### DETAILED DESCRIPTION OF THE INVENTION

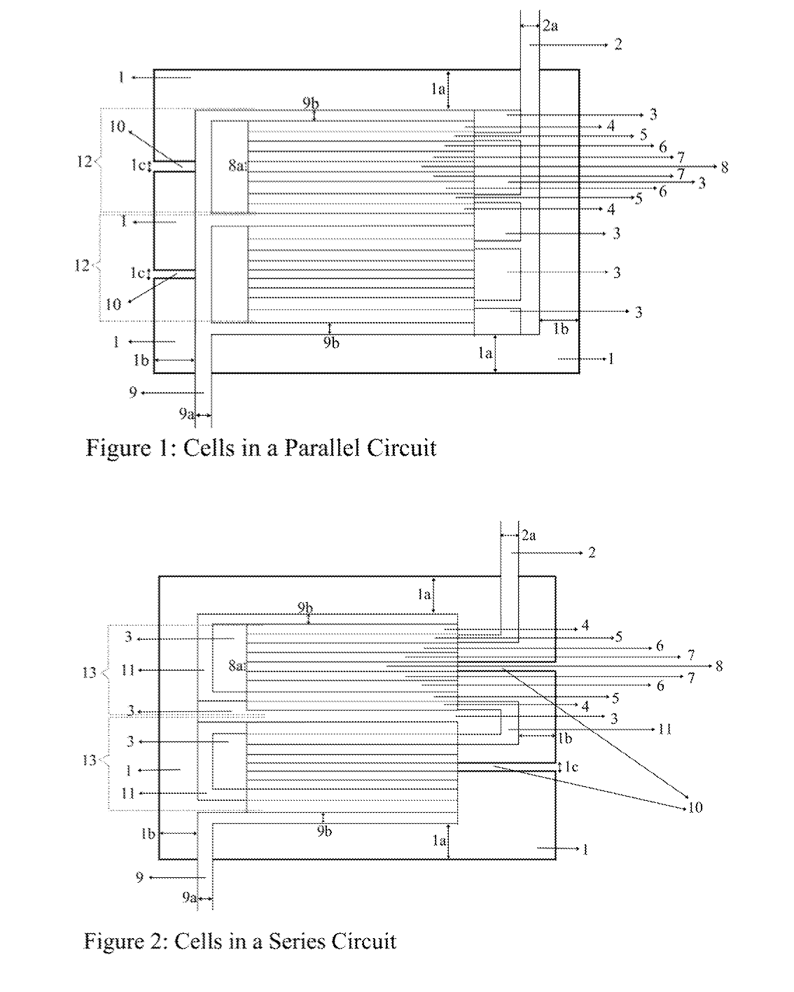

### Description of the Present Embodiments Shown in FIGS. 1 and 2

Element 1 is made up of concrete material, used to provide radiation shielding against neutrons, gamma rays, and electrons.

Elements 2 and 11 are electrical conductors with high melting temperature preferably but not limited to lead.

Element 3 is an electrical insulator with high melting temperature preferably but not limited to 3M™ Nextel™ Continuous Ceramic Oxide Fibre.

Elements 4 and 5 are collectively any diode, preferably but not restricted to the Schottky Barrier Diode. The Schottky Barrier Diode is a good candidate because of its high radiation resistance.

Element 4 is the part of the diode that has an overall positive charge at depletion region within it.

Element 5 is the part of the diode that has an overall negative charge at depletion region within it.

Element 6 is a material containing beta-decaying radioisotopes, preferably but not limited to Thorium-232, Nickel-63 or Carbon-14.

Element 7 is a moderating material within which fast neutrons collide with its atoms and lose kinetic energy to become slower thermal neutrons. Element 7 is preferably but not limited to graphite.

Element 8 is material containing fissile radioisotopes capable of sustaining a chain reaction.

Element 8 is preferably but not limited to Uranium-235.

Element 9 is an electrical conductor with high melting temperature preferably but not limited to lead.

Elements 10 are gaps in Element 1 allowing for the insertion of neutrons into Element 8 to initiate a chain reaction. The source of neutrons inserted through Elements 10 can come from but are not limited to Californium-252.

Element 12 is a cell comprising stacked layers of Elements 4, 5, 6, 7, 8, and 9.

Element 13 is a cell comprising stacked layers of Elements 3, 4, 5, 6, 7, and 8.

Elements 2, 4, 5, 6, 7, 8, and 9 can be, but are not restricted to, thin films fabricated using epitaxial deposition techniques like Chemical Vapour Deposition, Physical Vapour Deposition and Molecular Beam Epitaxy.

{Accumulation of Electrons in Element 9 and Accumulation of Holes in Element 2}

Referring to FIG. 1, when slow thermal neutrons are inserted though Elements 10 into Element 8, a chain reaction is initiated in Element 8. The fissile radioactive material in Element 8 absorbs thermal neutrons and fissions to produce fast neutrons. As the fast neutrons from Element 8 scatter into Element 7, they lose kinetic energy by colliding with the atoms in Element 7. Hence, fast neutrons are converted into slower thermal neutrons. Some of the thermal neutrons converted in Element 7 scatter back into Element 8 to cause further fission, thus sustaining the chain reaction. However, some thermal neutrons from Element 7 scatter into Element 6 where they are absorbed by the beta-decaying radioisotopes. This causes the beta-decaying radioisotopes to fission, thus producing beta particles. The beta particles produced in Element 6 scatter into Elements 5 and 4 where they create electron-hole pairs. The electrons created in Elements 5 and 4 are swept by the depletion region in the diode, into Element 4. These electrons then scatter into and accumulate in Element 9. The holes created in Elements 5 and 4 are swept by the depletion region in the diode, into Element 5. These holes then scatter into and accumulate in Element 2. Consequently, there is a build-up of electrons in Element 9 and holes in Element 2. This creates an electromotive force and potential current that can be utilized by connecting Elements 9 and 2 to an external circuit.

{Radiation Shielding}

Referring to FIG. 1, concrete material 1 is used to provide radiation shielding, preventing neutrons, alpha particles, beta particles and gamma rays from getting out of the battery. The thickness of the concrete material 1a and 1b can be varied to vary the amount of radiation shielding. Elements 2 and 9 are electrical conductors with high melting temperature preferably made from lead, so that they can provide additional radiation shielding against gamma and beta radiation. The thickness 9a, 9b, and 2a of Elements 9 and 2 can be varied to vary the amount of radiation shielding.

{Initialisation of Chain Reaction in Element 8}

Referring to FIG. 1, gaps 10 of width 1c in the concrete material 1 are made to allow the insertion of neutrons from a neutron source to initiate a chain reaction in the fissile Element 8. The neutron source is preferably but not restricted to Californium-252. After the insertion of neutrons through gaps 10, the gaps should be sealed with concrete to prevent harmful radiation from escaping from within the betavoltaic battery.

{Customisation by Varying Thickness of Elements 4, 5, 6, 7, and 8}

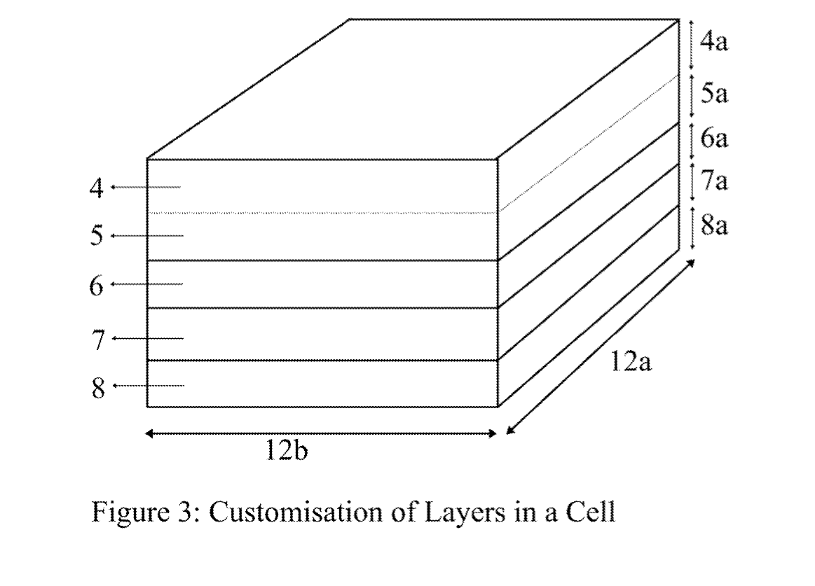

Referring to FIG. 1, the betavoltaic battery shown in FIG. 1 is highly customizable. Referring to FIG. 3, the thicknesses 7a and 8a can be varied to vary the fission rate and criticality of the chain reaction in Element 8. This in turn determines the run-time power generation and temperature of the betavoltaic battery. The thicknesses 4a, 5a, and 6a can be varied to vary the run-time power generation of the betavoltaic battery.

Referring to FIG. 3, the length 12a and breath 12b can be increased to increase the surface area and hence volume of each of the layers 4, 5, 6, 7 and 8. By increasing the volume of layer 8, more neutrons can be produced by the chain reaction in Element 8. This feeds more neutrons into Element 6. Element 6 which also has its surface area and volume enlarged can then absorb more thermal neutrons to produce more beta particles. This feeds more beta particles into Elements 4 and 5. Elements 4 and 5 which also have their surface area and volume enlarged can then absorb more beta particles to produce more electron-hole pairs. Thus, the power generated increases.

{Effect of the Thickness of Element 8 on the Criticality of the Chain Reaction}

Referring to FIG. 3, when the thickness 8a is reduced, the rate at which neutrons in Element 8 escape into Elements 7 and 6 is increased. This reduces the number of neutrons available from within Element 8 to cause fission by colliding with fissile nuclides in Element 8. Thus, the effective neutron multiplication factor in Element 8 is reduced. Hence, the criticality of the chain reaction in Element 8 is reduced. Conversely, when the thickness 8a is increased, neutrons remain within Element 8 for a longer time. This increases the number of fissions caused by neutrons colliding with fissile nuclides in Element 8. Hence, the criticality of the chain reaction in Element 8 is increased.

{Effect of the Thickness of Element 7 on the Criticality of the Chain Reaction in Element 8}

Referring to FIG. 3, when the thickness 7a is increased, fast neutrons escaping from Element 8 into Element 7 lose more kinetic energy because they would have to collide with more atoms in Element 7. This converts fast neutrons into much slower neutrons. Conversely, decreasing the thickness of Element 7 causes fast neutrons to lose less kinetic energy because these neutrons collide with fewer atoms in Element 7. This converts fast neutrons into less slow neutrons.

There exists range of kinetic energies for neutrons which corresponds to the maximum probability of the neutrons causing fission upon colliding with fissile radioisotopes in Element 8. By adjusting the thickness 7a, the range of kinetic energies of thermal neutrons can be adjusted to match the kinetic energies for which fission probability in Element 8 is maximum. By attaining the maximum fission probability possible, the maximum possible criticality of the chain reaction in Element 8 is attained.

{Condition for Safe Operation of Betavoltaic Battery}

Referring to FIG. 1, supercriticality increases the fission rate in Element 8. A higher fission rate in Element 8 will cause more heat energy to be released. This increases the temperature of the system. For the betavoltaic battery to operate safely, the thickness of Elements 7 and 8, and the fissile radioisotope concentration in Element 8 must be chosen such that Element 8 never heats up to the melting temperature of any of the Elements 4, 5, 6, 7, and 8.

{Effect of Varying the Thickness of Element 6 on Power Output}

Referring to FIG. 3, by increasing the thickness 6a, the number of beta-decaying radioisotopes in Element 6 is increased. This increases the probability of a thermal neutron from Element 7 colliding with a beta-decaying radioisotope. Hence, the rate at which beta-decaying radioisotopes undergo fission increases. Thus, more beta particles are produced. This should increase the power output of the betavoltaic battery. However, there reaches a thickness 6a beyond which beta particles do not have enough kinetic energy to scatter into Element 5. Power output may drop if Element 6 is fabricated beyond this thickness. Referring to FIG. 1, this introduces the need to stack a cell 12 comprising Elements 4, 5, 6, 7, 8, and 9, on top of identical cells 12 to form a parallel or series circuit of cells in order for power output to be increased.

{Stacking of Group to Create Parallel or Series Circuit}

As seen from FIG. 1, Elements 4, 5, 6, 7, 8 and the horizontal layer of Element 9 can be grouped together to form a cell 12. The cell 12 can be repeatedly stacked on top of identical cells 12 to provide more power. The horizontal layers of Elements 9 can be joined to the vertical part of Element 9. Likewise, Element 5 from each cell can be joined to Element 2. This creates a parallel circuit of multiple cells 12.

As seen from FIG. 2, Elements 3, 4, 5, 6, 7 and 8 can be grouped together to form a cell 13. The cell 13 can be repeatedly stacked on top of similar cells 13 to provide more power. Element 4 of each cell is electrically connected via Element 11 to either Element 5 of the cell adjacent to it or Element 5 belonging to its own cell. This creates a series circuit of multiple cells 13.

{Betavoltaic Battery in which Neutron Source has No Chain Reaction}

Another version of the betavoltaic battery uses neutron sources that do not sustain a chain reaction. Referring to FIG. 1, this is done by replacing Element 8 with a radioactive isotope that decays to produce neutrons. An example of a replacement for Element 8 is Californium-252 which is a rich source of neutrons. The replacement for Element 8 is not limited to Californium-252. In fact, any radioisotope capable of producing neutrons upon radioactive decay can be used to replace Element 8. Element 7 may be removed if the radioisotope produces neutrons that have kinetic energies low enough to cause fission in Element 6. The gaps 10 of width 1c shown in FIG. 1 should then be filled up with concrete for this version of the betavoltaic battery that does not need a chain reaction.

1. A betavoltaic device, comprising:
a layer of material containing fissile radioisotopes;
a layer of moderating material capable of reducing the kinetic energy of neutrons that collide with its constituent atoms, disposed immediately adjacent to the top of the said layer of material containing fissile radioisotopes;
a layer of material containing radioisotopes that can undergo radioactive decay to produce beta particles, disposed immediately adjacent to the top of the said layer of moderating material;
a layer of semiconductor diode, disposed immediately adjacent to the top of the said layer of material containing radioisotopes that can undergo radioactive decay to produce beta particles.

2. A betavoltaic device according to claim 1, in which:
is removed the said layer of moderating material capable of reducing the kinetic energy of neutrons that collide with its constituent atoms;
the said layer of material containing fissile radioisotopes is replaced by a layer of material containing radioisotopes capable of undergoing radioactive decay to produce neutrons.

3. The betavoltaic device as recited in claim 1, further comprising:
a layer of moderating material capable of reducing the kinetic energy of neutrons that collide with its constituent atoms, disposed immediately adjacent to the bottom of the said layer of material containing fissile radioisotopes;
a layer of material containing radioisotopes that can undergo radioactive decay to produce beta particles, disposed immediately adjacent to the bottom of the herein said layer of moderating material;
a layer of semiconductor diode, disposed immediately adjacent to the bottom of the herein said layer of material containing radioisotopes that can undergo radioactive decay to produce beta particles.

4. The betavoltaic device as recited in claim 1, further comprising:
a layer of moderating material capable of reducing the kinetic energy of neutrons that collide with its constituent atoms, disposed immediately adjacent to the bottom of the said layer of material containing fissile radioisotopes;
a layer of material containing radioisotopes that can undergo radioactive decay to produce beta particles, disposed immediately adjacent to the bottom of the herein said layer of moderating material;
a layer of semiconductor diode, disposed immediately adjacent to the bottom of the herein said layer of material containing radioisotopes that can undergo radioactive decay to produce beta particles;
a layer of electrically conducting material forming a negative electrode, disposed immediately adjacent to the bottom of the equivalent n-doped layer of the herein said layer of semiconductor diode;
a layer of electrically conducting material forming a negative electrode, disposed immediately adjacent to the top of the equivalent n-doped layer of the layer of semiconductor diode said in claim 1;
a layer of electrically conducting material forming a positive electrode, disposed immediately adjacent to the right of the equivalent p-doped layer of the herein said layer of semiconductor diode;
a layer of electrically conducting material forming a positive electrode, disposed immediately adjacent to the right of the equivalent p-doped layer of the layer of semiconductor diode said in claim 1.

5. A betavoltaic device according to claim 1, in which:
a layer of moderating material capable of reducing the kinetic energy of neutrons that collide with its constituent atoms, is disposed immediately adjacent to the bottom of the said layer of material containing fissile radioisotopes;
a layer of material containing radioisotopes that can undergo radioactive decay to produce beta particles, is disposed immediately adjacent to the bottom of the herein said layer of moderating material;
a layer of semiconductor diode, is disposed immediately adjacent to the bottom of the herein said layer of material containing radioisotopes that can undergo radioactive decay to produce beta particles;
a layer of electrically conducting material forming a negative electrode, is disposed immediately adjacent to the bottom of the equivalent n-doped layer of the herein said layer of semiconductor diode;
a layer of electrically conducting material forming a negative electrode, is disposed immediately adjacent to the top of the equivalent n-doped layer of the layer of semiconductor diode said in claim 1;
a layer of electrically conducting material forming a positive electrode, disposed immediately adjacent to the right of the equivalent p-doped layer of the herein said layer of semiconductor diode;
a layer of electrically conducting material forming a positive electrode, is disposed immediately adjacent to the right of the equivalent p-doped layer of the layer of semiconductor diode said in claim 1;
all of the said layers are collectively named a cell;
multiple identical cells separated by a layer of electrically insulating material are stacked on top of each other to form a battery stack;
the said electrodes in each cell within the said battery stack are connected via an electrical conductor to the electrodes of opposite polarity in both the adjacent cell and the same cell to form a series circuit, to form a battery unit;
an electrically insulating material encapsulates the entire said battery unit, less the part of the electrodes needed for electrical connection to an external circuit;
concrete material encapsulates both the said battery unit and said electrically insulating material, less the part of the electrodes needed for electrical connection to an external circuit;
gaps in the said concrete material are created, such that neutrons can be inserted into the said layer of material containing fissile radioisotopes.

6. A betavoltaic device according to claim 1, in which:
a layer of moderating material capable of reducing the kinetic energy of neutrons that collide with its constituent atoms, is disposed immediately adjacent to the bottom of the said layer of material containing fissile radioisotopes;
a layer of material containing radioisotopes that can undergo radioactive decay to produce beta particles, is disposed immediately adjacent to the bottom of the herein said layer of moderating material;
a layer of semiconductor diode, is disposed immediately adjacent to the bottom of the herein said layer of material containing radioisotopes that can undergo radioactive decay to produce beta particles;
a layer of electrically conducting material forming a negative electrode, is disposed immediately adjacent to the bottom of the equivalent n-doped layer of the herein said layer of semiconductor diode;
a layer of electrically conducting material forming a negative electrode, is disposed immediately adjacent to the top of the equivalent n-doped layer of the layer of semiconductor diode said in claim 1;
a layer of electrically conducting material forming a positive electrode, disposed immediately adjacent to the right of the equivalent p-doped layer of the herein said layer of semiconductor diode;
a layer of electrically conducting material forming a positive electrode, is disposed immediately adjacent to the right of the equivalent p-doped layer of the layer of semiconductor diode said in claim 1;
all of the said layers are collectively named a cell;
multiple identical cells separated by a layer of electrically insulating material are stacked on top of each other to form a battery stack;
the said electrodes in each cell within the said battery stack are connected via an electrical conductor to the electrodes of similar polarity in both the adjacent cell and the same cell to form a parallel circuit, to form a battery unit;
an electrically insulating material encapsulates the entire said battery unit, less the part of the electrodes needed for electrical connection to an external circuit;
concrete material encapsulates both the said battery unit and said electrically insulating material, less the part of the electrodes needed for electrical connection to an external circuit;
gaps in the said concrete material are created, such that neutrons can be inserted into the said layer of material containing fissile radioisotopes.

7. A betavoltaic device according to claim 1, in which the said layer of material containing fissile radioisotopes is Uranium-235.

8. A betavoltaic device according to claim 1, in which the said layer of material containing radioisotopes that can undergo radioactive decay to produce beta particles, is Thorium-232, Nickel-63 or Carbon-14.

9. A betavoltaic device according to claim 1, in which the said layer of moderating material is graphite or beryllium.

10. A betavoltaic device according to claim 1, in which the said layer of semiconductor diode is a Schottky barrier diode or a pn-junction made from silicon.

11. A betavoltaic device according to claim 1, in which all said layers are thin films epitaxially deposited on top of each other.
